(19) United States
(12) Patent Application Publication
(10) Pub. No.: US 2009/0207787 A1
(43) Pub. Date: Aug. 20, 2009

(54) RADIO BASE STATION, CONTROL APPARATUS, AND WIRELESS COMMUNICATION METHOD

(75) Inventors: Yoshiyasu Sato, Kanagawa (JP); Toshiteru Hayashi, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 11/816,407

(22) PCT Filed: Feb. 14, 2006
(86) PCT No.: PCT/JP2006/302555

§ 371 Date: Aug. 15, 2007

(30) Foreign Application Priority Data
Feb. 16, 2005 (JP) 2005-039261

(51) Int. Cl. H04W 72/04

(52) U.S. Cl. 370/329

(57) ABSTRACT

A radio base station capable of performing an optimum scheduling suitable for an outside situation. The radio base station, which has a scheduling table (125) in which it is designated what scheduling should be performed, temporally and dynamically changes scheduling methods to be used by a scheduling pattern selecting part (124), based on outside information (disaster situation, traffic situation, weather information, event information, etc.) determined by a intra-cell environment determining part (122) and also based on a request packet ratio from a request ratio determining part (123). In this way, an optimum scheduling can be performed in accordance with the latest situation in the cell.

### TECHNICAL FIELD

The present invention relates to a radio base station, control apparatus and wireless communication method that realize multi-media services.

### BACKGROUND ART

In recent years, since there has been a demand for radio communication systems with multi-media services, it is believed that control of these systems taking into consideration quality of service (hereinafter referred to as “QoS”) which differs depending on the type of application will become essential in the future. The requirements for traffic characteristics and network specified by the QoS differ depending on the type of application. Thus, it is considered that a network architecture and control technology which take into consideration the QoS, are essential in order to satisfy the requirements for QoS of the different applications employed in a mobile station.

Also, it is considered that in future networks, all protocols for paths between a transmitting side and a receiving side will be unified to IP (Internet Protocol). Thus, it is highly likely that conventional radio communication systems configured to employ a unique network will be converted to future systems that are based on IP. Systems employing the IP are based on packet communication.

As described above, in the radio communication system, it is necessary to introduce QoS-related control for packet communication. At this time, in the wireless communication system, the reception quality at the mobile station constantly changes, under the influence of variations in the channel environment and interferences caused by other signals. Thus, this requires particular consideration which differs from the cable communication systems. Various control techniques are proposed for the QoS in the wireless communication systems, based on the above-described background. At the same time, a method of performing scheduling is proposed for the mobile stations which do not require QoS, in which the transmission order is determined taking into account the fairness between the mobile stations.

In Patent Document 1, a method is proposed in which, in order to suitably control the transmission of packets, in the case that mobile stations with various service levels coexist inside a radio communication system, packets are sorted into quantitative guarantee-type packets having a required value of the communication quality, and relative guarantee-type packets not having such a required value, and the transmission order of these packets is controlled for each of the sorted quantitative guarantee-type packets and the relative guarantee -type packets. Then radio resources are allocated so as to satisfy the required value of the quantitative guarantee-type packets.

### Patent Document 1: Japanese Patent Application Laid-Open No. 2004-140604

### DISCLOSURE OF INVENTION

### Problems to be Solved by the Invention

However, according to the technology disclosed in Patent Document 1, with scheduling being performed taking into consideration solely the wireless condition of the individual users inside the cell, it is not possible to realize scheduling that is suitable for the external conditions such as disaster conditions, event information, traffic conditions, climate conditions and the like, inside the cell.

Also, according to the technology disclosed in Patent Document 1, radio resources are allocated in the order of: packets within quantitative guarantee rate→packets within relative guarantee rate→packets outside quantitative guarantee rate, and, when packets within the relative guarantee rate are transmitted, even if quantitative guarantee rate packets are received from a new user, radio resources cannot be allocated soon to this new user. Therefore, this technology does not suitably accommodate users that desire to communicate quantitative guarantee-type packets.

Further, in the technology disclosed in Patent Document 1, when a buffer accommodates quantitative guarantee-type packets and relative guarantee-type packets, and the buffer has no more available space, in the case that quantitative guarantee-type packets are sent from a new user, these new quantitative guarantee-type packets are discarded, and as a result, the relative guarantee is given priority over the new quantitative guarantee. Specifically, when it is desired to increase the amount of quantitative guarantee-type users as much as possible, the allocation of radio resources and buffer cannot be optimally controlled.

It is therefore an object of the present invention to provide a radio base station, control apparatus and wireless communication method capable of performing scheduling in accordance with external conditions, such as disaster conditions, event information, traffic conditions, weather conditions, etc, inside a cell.

### Means for Solving the Problem

The radio base station according to the present invention adopts a configuration which comprises: a packet sorting section that sorts packets into quantitative guarantee type packets having a required value for quality of communication and relative guarantee type packets not having the required value; a proportion determining section that determines a proportion of the quantitative guarantee type packets to the relative guarantee type packets sorted by the packet sorting section, and a total amount of required packets; an intra-cell environment determining section that determines an intra-cell environment based on external information required from a public network; a scheduling table that provides in advance different types of scheduling patterns; a scheduling pattern selecting section that retrieves an applicable scheduling pattern from the scheduling table based on the proportion and the total amount of required packets determined by the proportion determining section, and external conditions inside the cell determined by the intra-cell environment determining section; a scheduling processing section that performs scheduling of a transmission order of the quantitative guarantee type packets and relative guarantee type packets sorted by the packet sorting section, based on the scheduling pattern selected by the scheduling pattern selecting section; and a radio resource allocating section that performs an allocation of radio resources to the quantitative guarantee type packets and relative guarantee type packets scheduled by the scheduling processing section.

The control apparatus of the present invention controls a radio base station that controls a radio base station that communicates packets with a plurality of mobile stations, the control apparatus comprising: a packet sorting section that sorts packets into quantitative guarantee type packets having a required value for quality of communication and relative guarantee type packets not having said required value; a proportion determining section that determines a proportion of the quantitative guarantee type packets to the relative guarantee type packets sorted by the packet sorting section, and a total amount of required packets; an intra-cell environment determining section that determines an intra-cell environment based on external information required from a public network; a scheduling table that provides in advance different types of scheduling patterns; a scheduling pattern selecting section that retrieves an applicable scheduling pattern from the scheduling table based on the proportion and the total amount of required packets determined by the proportion determining section, and external conditions inside the cell determined by the intra-cell environment determining section; a scheduling processing section that performs scheduling of a transmission order of the quantitative guarantee type packets and relative guarantee type packets sorted by the packet sorting section, based on the scheduling pattern selected by the scheduling pattern selecting section; and a radio resource allocating section that performs an allocation of radio resources to the quantitative guarantee type packets and relative guarantee type packets scheduled by the scheduling processing section.

The wireless communication method of the present invention comprises: a packet sorting step of sorting packets into quantitative guarantee type packets having a required value for quality of communication and relative guarantee type packets not having said required value; a proportion determining step of determining a proportion of the quantitative guarantee type packets to the relative guarantee type packets sorted in the packet sorting step, and a total amount of required packets; an intra-cell environment determining step of determining an intra-cell environment based on external information required from a public network; a scheduling pattern selecting step of retrieving an applicable scheduling pattern from a scheduling table, said table providing in advance different types of scheduling patterns, based on the proportion and the total amount of required packets determined in the proportion determining step, and external conditions inside the cell determined in the intra-cell environment determining step; a transmission order control step of performing scheduling of a transmission order of the quantitative guarantee type packets and relative guarantee type packets sorted in the packet sorting step, based on the scheduling pattern selected in the scheduling pattern selecting step; and performing an allocation of radio resources to the quantitative guarantee type packets and relative guarantee type packets scheduled in the scheduling processing step.

### Advantageous Effects of the Invention

According to the present invention, it is possible to provide a radio base station, control apparatus and wireless communication method capable of performing scheduling suitable for external conditions such as disaster conditions, event information, traffic conditions, weather conditions, etc., inside a cell.

### BRIEF DESCRIPTION OF DRAWINGS

FIG. 1 is a block diagram showing a configuration of a radio communication system according to embodiment 1 of the present invention;

FIG. 2 is a flowchart for describing the basic operation in the case that the radio base station shown in FIG. 1 sends a packet which arrived from a core network, to inside a cell;

FIG. 3 is a flowchart for describing the operation in the case that the radio station apparatus shown in FIG. 1 preferentially sends a quantitative guarantee-type packet which arrived from the core network to inside the cell;

FIG. 4 is a block diagram showing a configuration of a radio communication system according to embodiment 2 of the present invention;

FIG. 5 is a block diagram showing a configuration of a radio communication system according to embodiment 3 of the present invention;

FIG. 6 is a flowchart for describing the basic operation in the case that the radio base station shown in FIG. 5 sends the packets which arrived from a core network, to inside a cell;

FIG. 7 is a block diagram showing the configuration of a radio communication system according to embodiment 4 of the present invention;

FIG. 8 is a view for describing a conventional radio resource allocating method (first example);

FIG. 9 is a view for describing a conventional radio resource allocating method (second example);

FIG. 10 is a view for describing a radio resource allocating method (first example) of a radio base station according to embodiment 5 of the present invention;

FIG. 11 is a view for describing the radio resource allocating method (second example) of the radio base station according to embodiment 5 of the present invention;

FIG. 12 is a flowchart for describing a scheduling process and radio resource allocation control in the radio base station according to embodiment 5 of the present invention;

FIG. 13 is a flowchart for describing a scheduling process and radio resource allocation control in a radio base station according to embodiment 6 of the present invention;

FIG. 14 is a view for describing a radio resource allocating method (first example) in a radio base station according to embodiment 7 of the present invention;

FIG. 15 is a view for describing a radio resource allocating method (second example) in a radio base station according to embodiment 7 of the present invention;

FIG. 16 is a flowchart for describing a scheduling process and radio resource allocation control in the radio base station according to embodiment 7 of the present invention;

FIG. 17 is a view for describing a radio resource allocating method (first example) in a radio base station according to embodiment 8 of the present invention;

FIG. 18 is a view for describing the radio resource allocating method (second example) in a radio base station according to embodiment 8 of the present invention;

FIG. 19 is a view for describing the radio resource allocating method (third example) in a radio base station according to embodiment 8 of the present invention; and

FIG. 20 is a view for describing a radio resource allocating method in a radio base station according to embodiment 9 of the present invention.

### BEST MODE FOR CARRYING OUT THE INVENTION

Next, the embodiments of the present invention will be described in detail, with reference to the accompanying drawings.

### Embodiment 1

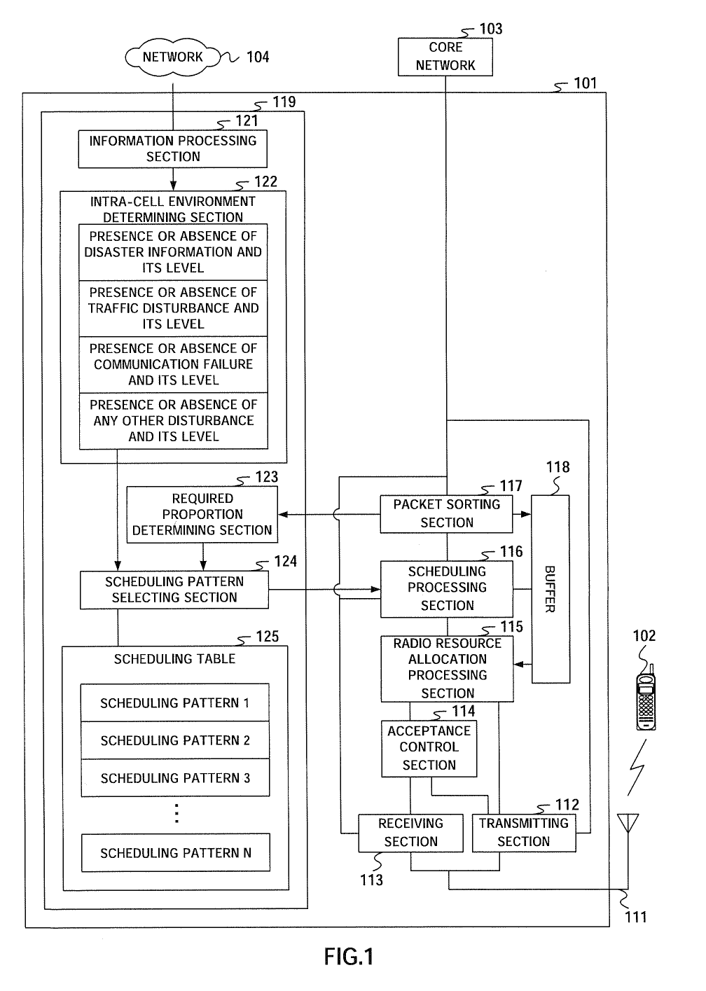

FIG. 1 is a block diagram showing a configuration of a radio communication system according to embodiment 1 of the present invention. The radio communication system shown in FIG. 1 comprises: radio base station 101, a plurality of mobile stations 102 that are connected by radio in a cell in radio base station 101, core network 103 and public network 104 to which radio base station 101 is wire-connected.

Radio base station 101 comprises antenna 111, transmitting section 112, receiving section 113, acceptance control section 114, radio resource allocation processing section 115, scheduling processing section 116, packet sorting section 117, buffer 118, and scheduling deciding section 119.

Scheduling deciding section 119 comprises information processing section 121, intra-cell environment determining section 122, required proportion determining section 123, scheduling pattern selecting section 124, and scheduling table 125. Scheduling table 125 contains different types of scheduling patterns which are set up in advance. These settings may be made during the design phase, or may be acquired by radio communication from radio base station 101.

Transmitting section 112 transmits packets to the mobile stations inside the cell, via antenna 111. When the packets transmitted from core network 103 to the mobile stations arrive at radio base station 101, transmitting section 112 reports the arrival of the packets, to the above-mentioned mobile stations. Transmitting section 112 transmits the packets, to which radio resources inputted from radio resource allocation processing section 115 are allocated, to the above-mentioned mobile stations.

Receiving section 113 receives the packets from the mobile stations inside the cell, via antenna 111. When the mobile stations inside the cell receive a report of the arrival of packets for these mobile stations from radio base station 101, the mobile stations transmit, to radio base station 101, control information such as scheduling information or the like that radio base station 101 employs to decide the information relative to the quality of communication and the transmission order of packets. Receiving section 113 delivers the control information received from mobile stations 102 to scheduling processing section 116 and packet sorting section 117. When receiving section 113 receives a new connection request from mobile stations 102, receiving section 113 sends the received connection request to acceptance control section 114. Acceptance control section 114 generates a response and delivers the response to transmitting section 112, and the response is transmitted to mobile stations 102.

Buffer 118 is composed of a plurality of transmit buffers that store packets to be transmitted to the mobile stations. Here, buffer 118 is composed of 1 through n quantitative guarantee-type transmit buffers, that store quantitative guarantee-type packets having a required value for communication quality, and n+1 through N relative guarantee-type transmit buffers, that store relative guarantee-type packets not having a required value for communication quality.

When the packets to be transmitted to the mobile stations arrive from core network 103 at radio base station 101, packet sorting section 117 sorts the arrived packets into quantitative guarantee-type packets and relative guarantee-type packets, stores these packets in the corresponding transmit buffers in buffer 118, and delivers them to scheduling processing section 116 and required proportion determining section 123.

Using the scheduling patterns selected by scheduling pattern selecting section 124, scheduling processing section 116 controls the transmission order of the sorted packets stored in buffer 118, for each quantitative guarantee-type packet and relative guarantee-type packet selected by packet sorting section 117. At this time, if radio resources are left, scheduling processing section 116 performs scheduling of the next packets, based on the quantity of remaining radio resources for which a report from radio resource allocation processing section 115 is received.

Radio resource allocation processing section 115 allocates radio resources to these packets, according to packet transmission order controlled by scheduling processing section 116. Also, radio resource allocation processing section 115 retrieves the packets from buffer 118, and allocates radio resources to these packets. If radio resource allocation processing section 115 has exhausted the radio resources, it reports to scheduling processing section 116 that no radio resources are left. Then, radio resource allocation processing section 115 delivers the packets to which radio resources are allocated, to transmitting section 112. Radio resource allocation processing section 115 allocates frequency band, transmit power, time slot, and the like, for instance, as radio resources.

On the other hand, in scheduling deciding section 119, information processing section 121 acquires the external conditions (for instance, disaster conditions, event information, traffic conditions, weather conditions, etc.) from public network 104 such as the Internet, assesses these conditions and delivers the assessed external conditions to intra-cell environment determining section 122.

Intra-cell environment determining section 122 determines the level of the external environment inside the cell, based on the information from information processing section 121, and delivers the determined information to scheduling pattern selecting section 124. The determined information includes, for instance, “the presence or absence of disaster information and its level”, “the presence or absence of traffic disturbance and its level”, “the presence or absence of communication failure and its level”, “the presence or absence of other disturbance and its level”.

Required proportion determining section 123 determines the proportion of the amounts of the quantitative guarantee-type packets and relative guarantee-type packets sorted by packet sorting section 117 and the total amount of required packets, and delivers these to scheduling pattern selecting section 124.

Scheduling pattern selecting section 124 determines which scheduling pattern to use, from a plurality of scheduling patterns (scheduling patterns 1 though scheduling pattern N) set up in scheduling table 125, based on the proportion of qualitative guarantee-type packets and relative guarantee-type packets and the total amount of required packets, inputted from required proportion determining section 123, and based on the external environment inside the cell inputted from intra-cell environment determining section 122, and delivers the selected scheduling pattern to scheduling processing section 116.

The above is a summary of the operation of each element in a downlink channel system transmitting packets from radio base station 101 to the mobile stations inside the cell. In the present specification, description will be given on the operation in this downlink channel system. However, as can be noted from the fact that receiving section 113 delivers the packets received from the mobile stations to packet sorting section 117, and delivers the packets received from the mobile stations to core network 103, it is obvious that a similar operation is also carried out in an uplink channel system transmitting packets from the mobile stations inside the cell, to radio base station 101.

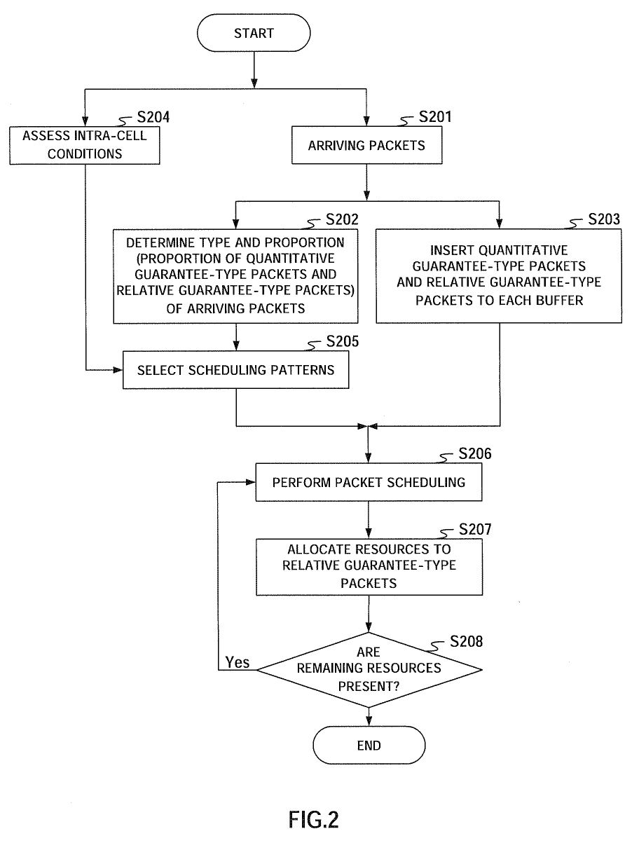

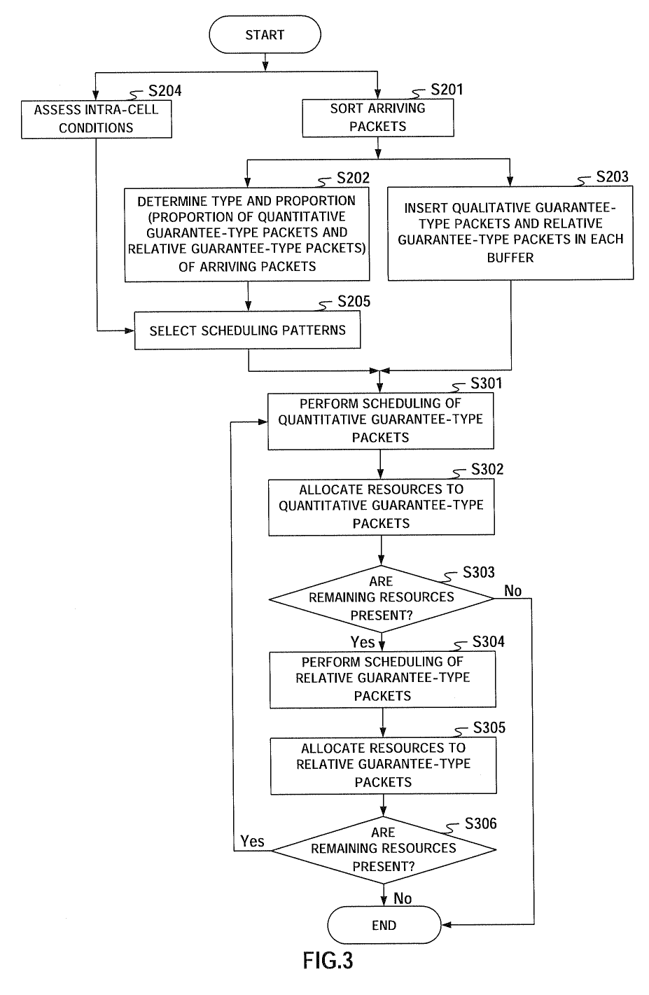

Next, the operation of radio base station 101 having the above-described configuration will be described with reference to FIG. 1 through FIG. 3. FIG. 2 is a flowchart for describing the basic operation in the case that radio base station 101 shown in FIG. 1 transmits packets that arrive from core network 103, to inside the cell. FIG. 3 is a flowchart for describing the operation in the case that radio base station 101 shown in FIG. 1 preferentially transmits quantitative guarantee-type packets that arrive from core network 103, to inside the cell.

As shown in FIG. 2, packets that arrive from core network 103 at radio base station 101 are sorted into quantitative guarantee-type packets and relative guarantee-type packets (step S201). Next, the proportion of arriving packets with the sorted quantitative guarantee-type packets and relative guarantee-type packets, and the amount of required packets, are calculated (step S202). In parallel with the proportion calculation process (step S202), the sorted quantitative guarantee-type packets and relative guarantee-type packets are inputted to buffer 118 (step S203).

Also, in parallel with the sorting process of arriving packets (step S201), the condition inside the cell is assessed (step S204). Then, the optimal scheduling pattern for the arriving packets (the sorted quantitative guarantee-type packets and relative guarantee-type packets) is selected from scheduling table 125, based on the assessed condition inside the cell, and the type and rate of arriving packets (step S205). Next, scheduling of arriving packets is performed based on the selected scheduling pattern (step S206), and radio resources are allocated to the above-mentioned packets (in FIG. 2, shown as relative guarantee-type packets) (step S207). Then, the presence or absence of remaining radio resources is checked (step S208), and, if remaining radio resources are present (“Yes” in step S208), the flow returns to step S206, in which packet scheduling is performed once again, whereas, if no remaining radio resources are present (“No” in step S208), the flow ends.

Next, the case where priority is given to quantitative guarantee-type packets will be described. In this case, as shown in FIG. 3, the processes of step S301 through step S306 are performed in place of the processes of step S206 to step S208 shown in FIG. 2.

As shown in FIG. 3, first, scheduling of quantitative guarantee-type packets is carried out (step S301) based on the selected scheduling pattern (step S205) and radio resources are allocated to the quantitative guarantee-type packets (step S302). Then, the presence or absence of remaining radio resources is checked (step S303), and if no remaining radio resources are present (“No” in step S303), the flow ends there, whereas, if remaining radio resources are present (“Yes” in Step S303), next, scheduling of relative guarantee-type packets is performed (step S304), and radio resources are allocated to these relative guarantee-type packets (step S305). Then, the presence of remaining radio resources is checked once again (step S306), and if no radio resources are present (“No” in step S306), the flow ends, whereas, if remaining radio resources are present (“Yes” in step S306) the flow returns to step S301, in which scheduling of quantitative guarantee-type packets is performed once again.

Thus, according to the present embodiment 1, in a radio communication system accommodating a scheduling table that specifies what scheduling is to be carried out, the scheduling method to be used can dynamically vary over time based on the external information (disaster conditions, traffic conditions, weather information, event information and the like), it is possible to perform optimal scheduling according the conditions inside the cell at applicable times and perform priority control for quantitative guarantee-type packets according to external information.

### Embodiment 2

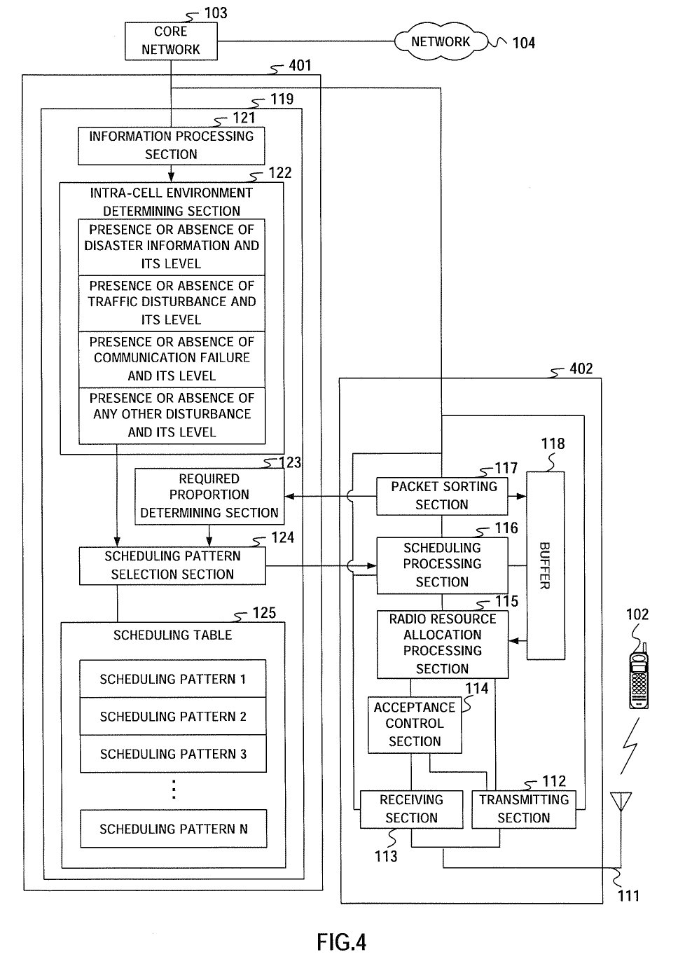

FIG. 4 is a block diagram showing a radio communication system according to embodiment 2 of the present invention. In FIG. 4, components that are identical to or equivalent to components shown in FIG. 1 (embodiment 1) are assigned the same reference numerals. Here, parts relating to embodiment 2 will be the focus of description.

As shown in FIG. 4, in the radio communication system according to embodiment 2, radio base station 101 shown in FIG. 1 (embodiment 1) is divided into RNC (Radio Network Controller) 401 and radio base station 402, both of which are connected in parallel to core network 103, and public network 104 is connected to core network 103.

RNC 401 comprises scheduling deciding section 119 shown in FIG. 1 (embodiment 1). Radio base station 402 comprises antenna 11, transmitting section 112, receiving section 113, acceptance control section 114, radio resource allocation processing section 115, scheduling processing section 116, packet sorting section 117 and buffer 118, that are shown in FIG. 1 (embodiment 1).

The system having the above-described configuration has the same operation as that described in embodiment 1, and therefore, the same effects as those of embodiment 1 are achieved.

### Embodiment 3

FIG. 5 is a block diagram showing a configuration of a radio communication system according to embodiment 3 of the present invention. In FIG. 5, components that are identical with or equivalent to components shown in FIG. 1 (embodiment 1) are assigned the same reference numerals. Here, parts relating to embodiment 3 of the present invention will be the focus of description.

As shown in FIG. 5, the radio communication system according to embodiment 3 of the present invention comprises radio base station 501, a plurality of mobile stations 102 which are radio connected in a cell of radio base station 501, and core network 103 to which radio base station 501 is wire-connected.

Radio base station 501 is provided with scheduling deciding section 510, in place of scheduling deciding section 119 in radio base station 101 shown in FIG. 1 (embodiment 1). Scheduling deciding section 510 is provided with timer section 511, database section 512, required proportion determining section 513 and comparison checking section 514, in place of information processing section 121, intra-cell environment determining section 122 and required proportion determining section 123, in scheduling deciding section 119 shown in FIG. 1 (embodiment 1).

Similar to required proportion determining section 123 shown in FIG. 1 (embodiment 1), required proportion of the amounts of packets of quantitative guarantee-type packets and relative guarantee-type packets sorted by packet sorting section 117 and the amount of required packets. The determined results are outputted to timer section 511, database section 512 and comparison checking section 514.

Timer section 511 measures the time at a point in time that is determined by required proportion determining section 513, and outputs the result to database section 512 and comparison checking section 514.

Database section 512 saves the proportion and the required packet amount determined by required proportion determining section 513, generates an average value such as weekly average values or monthly average values, or the like, of the proportion and the required packet amount, by using the time assessed by timer section 511, and stores these values.

Comparison checking section 514 compares the past records stored in database section 512 with the required packet amount determined by required proportion determining section at the packet arrival time measured by timer section 51 and the required proportion of the quantitative guarantee-type packets to relative guarantee-type packets, to assess the change condition, and delivers the result to scheduling pattern selecting section 124. If a change equal to or above a fixed value has occurred within a given interval, towards an increase in the amount of packets, it is determined, by comparison checking section 514, that some kind of event or disaster has occurred.

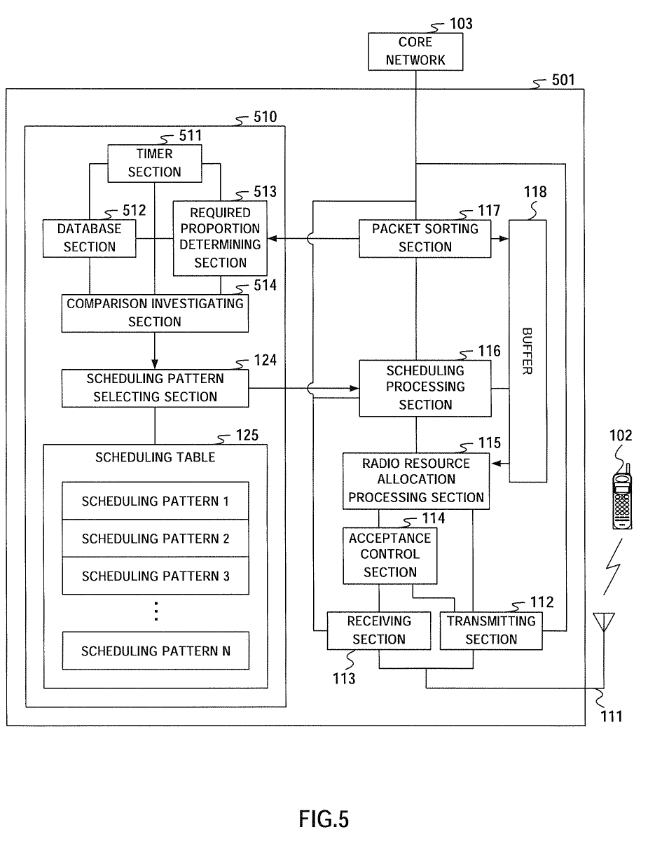

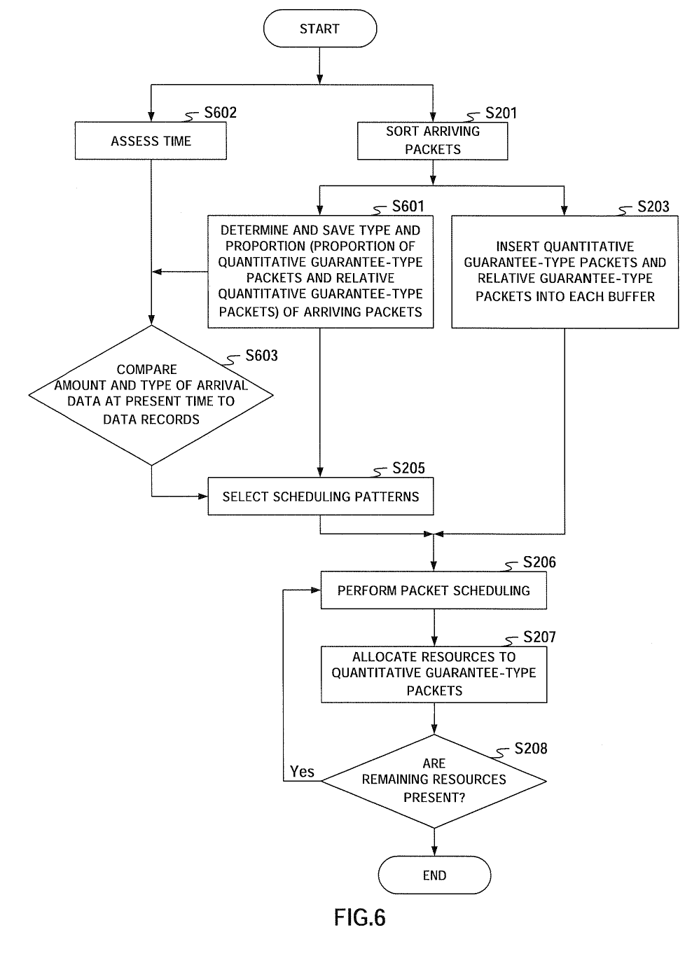

Next, the operation of radio base station 501 having the above-described configuration will be described with reference to FIG. 5 and FIG. 6. FIG. 6 is a flowchart for describing the basic operation in the case that radio base station 501 shown in FIG. 5 sends the packets that arrive from the core network to inside the cell.

As shown in FIG. 6, the packets that arrive from core network 103 at radio base station 501 are sorted into quantitative guarantee-type packets and relative guarantee-type packets (step S201). Next, the proportion of sorted quantitative guarantee-type packets to relative guarantee-type packets and the required amount of arriving packets are calculated and are stored in database section 512 (step S601). In parallel with the proportion calculation and storing process (step S601), the quantitative guarantee-type packets and the relative guarantee-type packets are inserted into buffer 118 (step S203).

In parallel with the sorting process of arriving packets (step S201), the present time is assessed (step S602). Then, the amount and type of arriving packets at the present time are compared to data record, to determine whether a change equal to or above a fixed value has occurred (step S603). The optimum scheduling pattern for the arriving packets (the sorted quantitative guarantee-type packets and relative guarantee-type packets) is selected from scheduling table 125, based on the results of the above determination, the amount and type of arriving packets, and data record (step S205).

Next, scheduling of arriving packets will be carried out based on the selected scheduling pattern (step S206), and radio resources are allocated to the above-mentioned packets (which are quantitative guarantee-type packets in FIG. 6) (step S207). Then, the presence or absence of remaining radio resources is checked (step S208), and, if remaining radio resources are present (“Yes” in step S208), the flow returns to step S206, in which the packets are scheduled once again, whereas, if no remaining radio resources are present (“No” in step S208), the flow ends.

Radio base station 501 shown in FIG. 5 is capable of executing the operation in the case that quantitative guarantee-type packets that arrive from the core network are preferentially sent to inside the cell, in the same steps as the steps shown in FIG. 3 (step S301 through step S306).

Thus, according to the present embodiment 3, irrespective of whether the mobile stations and the radio base station are synchronized or not, the time, the proportion of required quantitative guarantee-type packets and required relative guarantee-type packets, and the total amount of required packets are assessed, and their weekly average values and monthly average values or the like are stored, for comparison with the proportion of required quantitative guarantee-type packets and required relative guarantee-type packets and the total amount of required packets at applicable times, so that, if a change of a certain magnitude or greater occurs within a given interval, towards an increase in the amount of packets, it is determined that some kind of event or disaster has occurred, and the scheduling method can be changed.

As a specific example, it is possible to perform scheduling in accordance with conditions, such as, not accepting qualitative guarantee-type packets for streaming and moving picture and the like and accepting qualitative guarantee-type packets such as speech communication. Thus, it is possible to perform optimum scheduling according to the condition inside the cell at the time.

### Embodiment 4

FIG. 7 is a block diagram showing a configuration of the radio communication system according to embodiment 4 of the present invention. In FIG. 7, components that are identical with or equivalent to the components shown in FIG. 5 (embodiment 3) are assigned the same reference numerals. Here, parts relating to the present embodiment 4 will be the focus of description.

As shown in FIG. 7, the radio communication system according to the present embodiment 4 has a configuration in which radio base station 501 shown in FIG. 5 (embodiment 3) is divided into RNC (Radio Network Controller) 701 and radio base station 702, with radio base station 702 being connected to core network 103, via RNC 701.

RNC 701 comprises scheduling deciding section 510 shown in FIG. 5 (embodiment 3). Also, similar to radio base station 402 shown in FIG. 4 (embodiment 2), radio base station 702 comprises antenna 111, transmitting section 112, receiving section 113, acceptance control section 114, radio resource allocation processing section 115, scheduling processing section 116, packet sorting section 117 and buffer 118.

Since the operation carried out in the system with the above configuration is the same as that described in embodiment 3 (FIG. 6), the same effects as those of embodiment 3 are obtained.

Here, the operations of scheduling processing section 116 and radio resource allocation processing section 115 provided in the radio base station in the above-described embodiments will be next described in an embodiment. These operations correspond to the contents of the scheduling patterns in scheduling table 125.

### Embodiment 5

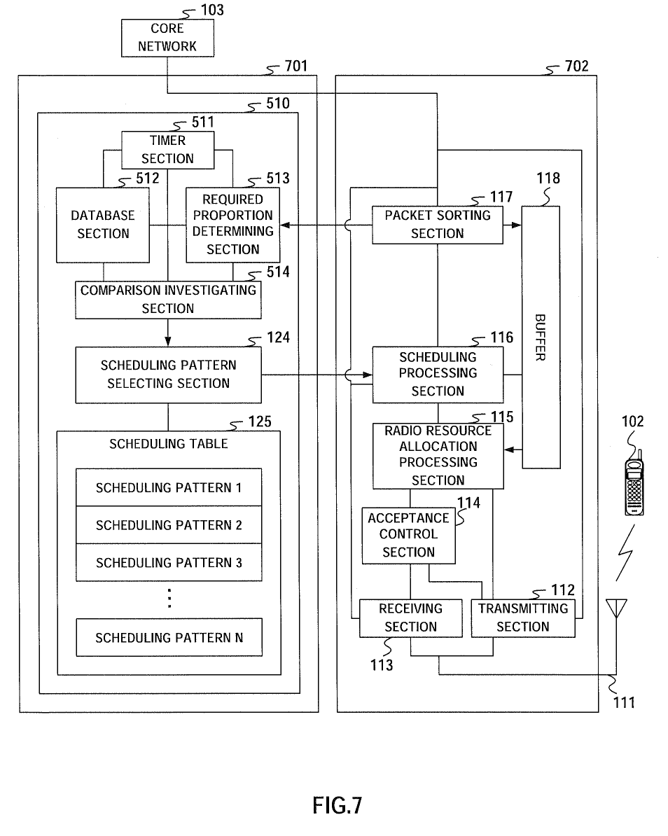

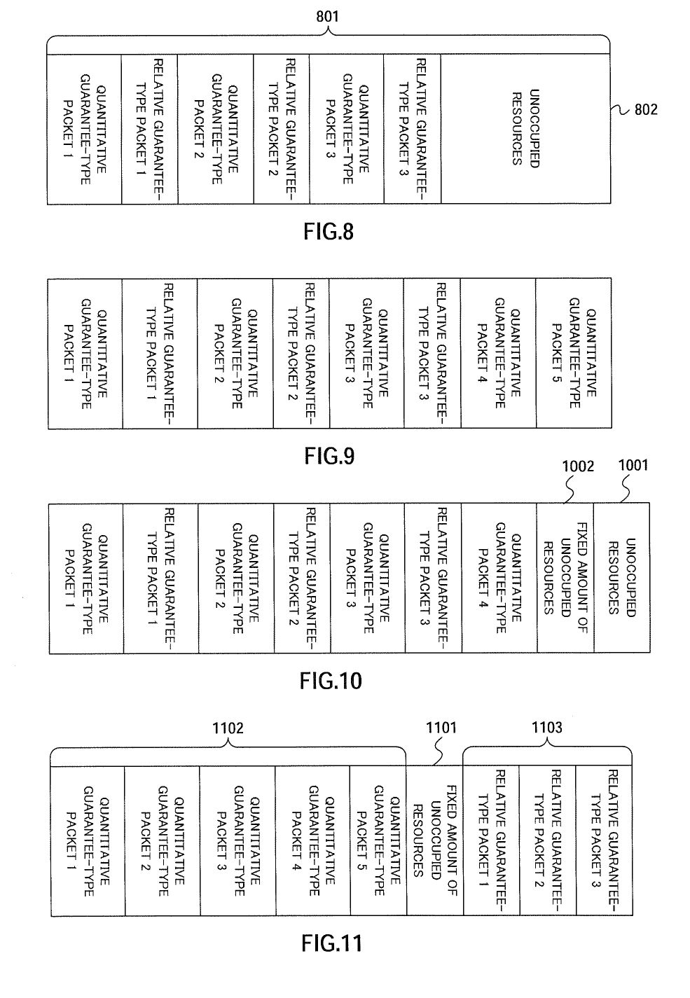

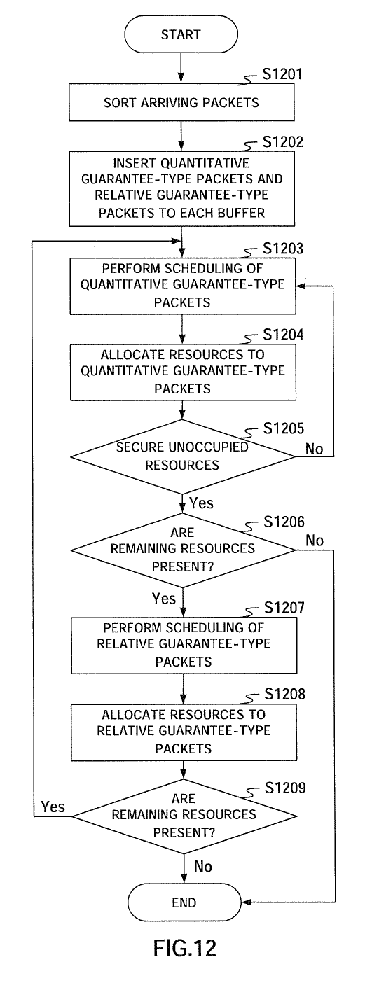

FIG. 8 through FIG. 12 are views for describing the scheduling process and radio resource allocation control in the radio base station according to embodiment 5 of the present invention. FIG. 6 and FIG. 9 are views for describing the conventional radio resource allocating method disclosed in Patent Document 1. FIG. 10 and FIG. 11 are views for describing the radio resource allocating method in the radio base station according to embodiment 5 of the present invention. FIG. 12 is a flowchart for describing the scheduling process and radio resource allocation control in the radio base station according to embodiment 5 of the present invention.

In the radio resource allocating method disclosed in Patent Document 1, if N quantitative guarantee-type packets (N is a natural number equal to or higher than 1) and N relative guarantee-type packets arrive from core network 103 at packet sorting section 117 at the same time, radio resources from all resources 801 are alternately allocated to qualitative guarantee-type packets and relative guarantee-type packets, and a limited amount of unoccupied resources 802 are left. Then, if radio resources are exhausted with these qualitative guarantee-type packets and relative guarantee-type packets, no unoccupied resources 802 will be left, as shown in FIG. 9, for instance.

In contrast to this, in embodiment 5, after resources are allocated to quantitative guarantee-type packets and relative guarantee-type packets, a predetermined amount of unoccupied resources 1002 is secured, in addition to unoccupied resources 1001, as shown in FIG. 10. If these resources cannot be secured, radio resources are not allocated to the new quantitative guarantee-type packets and relative guarantee-type packets.

In the present embodiment 5, a predetermined amount of unoccupied resources 1101 are secured, and radio resources on both sides sandwiching the unoccupied resources 1101 are sorted in advance into resources for quantitative guarantee-type packets 1102 and resources for relative guarantee-type packets 1103.

In this way, by giving priority to quantitative guarantee-type packets, it is possible to secure radio resources for quantitative guarantee-type packets such as emergency reports or the like having a high level of priority. Next, a description will be given with reference to FIG. 12.

In FIG. 12, packets that arrive at the radio base station from core network 103 are sorted into quantitative guarantee-type packets and relative guarantee-type packets (step S1201), and the sorted quantitative guarantee-type packets and relative guarantee-type packets are inserted into buffer 118 (step S1202). Then, scheduling of quantitative guarantee-type packets is first carried out (step S1203), and then radio resources are allocated to quantitative guarantee-type packets (step S1204).

Then, it is checked if it is possible to secure predetermined unoccupied resources (step S1205) If it is not possible to secure unoccupied resources (“No” in step S12), the flow returns to step S1203, in which scheduling of quantitative guarantee-type packets is carried out once again. If it is possible to secure unoccupied resources (“Yes” in step S1205), these unoccupied resources are secured, and the presence or absence of remaining radio resources after the unoccupied resources are secured, is checked (step S1206). If remaining radio resources are not present (“No” in step S1206), the flow ends there, but, if remaining radio resources are present (“Yes” in Step S1206), scheduling and radio resource allocation control for relative guarantee-type packets (step S1207) are carried out next (step S1208).

Then, the presence or absence of remaining radio resources is further checked (step S1209). If remaining radio resources are present (“Yes” in step S1209), the flow returns to step S1203, in which scheduling of quantitative guarantee-type packets is carried out If remaining radio resources are not present (“No” in step S1209), the flow ends here.

According to the present embodiment 5, since a required amount (necessary amount)+α of quantitative guarantee-type radio resources, which are accepted at that time, are secured in preparation for the case that a request occurs for quantitative guarantee-type packets, such as emergency calls, etc., with a high level of priority, it is possible to reliably secure radio resources for the packets with a high level of priority, from the quantitative guarantee-type packets.

### Embodiment 6

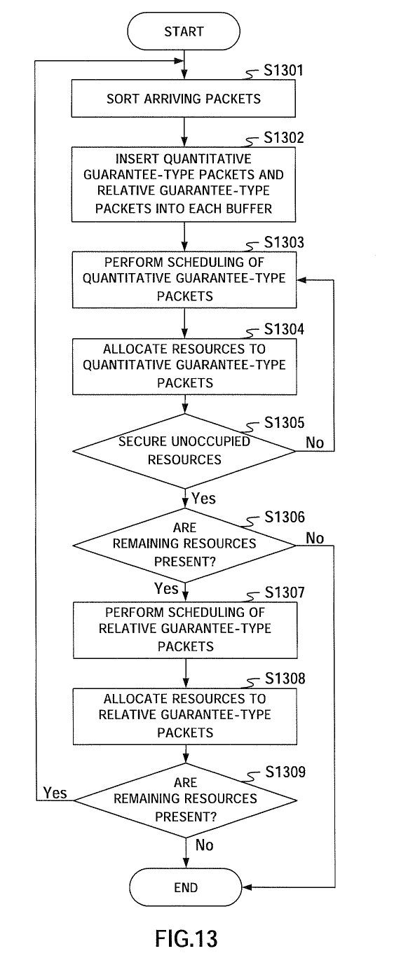

FIG. 13 is a flowchart for describing the scheduling process and radio resource allocation control in the radio base station according to embodiment 6 of the present invention. In the present embodiment 6, a method is described which suitably accommodates a user requesting new quantitative guarantee-type packets.

In FIG. 13, packets that arrive at the radio base station from core network 103 are sorted into quantitative guarantee-type packets and relative guarantee-type packets (step S1301), and the sorted quantitative guarantee-type packets and relative guarantee-type packets are inserted into buffer 118 (step S1302). Then, scheduling of quantitative guarantee-type packets is carried out (step S1303), and radio resources are allocated to the quantitative guarantee-type packets (step S1304).

Then, it is checked whether or not it is possible to secure predetermined unoccupied resources (step S1305). If it is not possible to secure unoccupied resources (“No” in step S1305), the flow returns to step S1303, in which scheduling of quantitative guarantee-type packets is carried out once again. If it is possible to secure unoccupied resources (“Yes” in step S1305), unoccupied resources are secured, and the present or absence of remaining radio resources, after unoccupied resources are secured, is checked (step S1306). If remaining radio resources are not present (“No” in step S1306), the flow ends, whereas, if remaining radio resources are present (“Yes” in Step S1306), scheduling (step S1307) and radio resource allocation control (step S1308) for relative guarantee-type packets are carried out.

Then, the presence or absence of remaining radio resources is further checked (step S1309). If remaining radio resources are present (“Yes” in step S1309), the flow returns to step S1301, and the sequence of operations including acceptance of packets from a new user, packet sorting and the like are carried out. If remaining radio resources are not present (“No” in step S1309), the flow ends here. The process for securing unoccupied resources (step S1305) is not material and may be applied as needed.

In the radio resource allocating method disclosed in Patent Document 1, since allocation of radio resources is performed in the order of: packets within the quantitative guarantee rate→packets within the relative guarantee rate→packets outside the quantitative guarantee rate, and so it is not possible to increase the number of users.

Contrary to this, in the present embodiment 6, when there are available radio resources, these can be allocated to the user requesting new, quantitative guarantee-type packets. Accordingly, radio resources can be preferentially allocated to speech communication, thereby increasing the number of users capable of speech communication.

### Embodiment 7

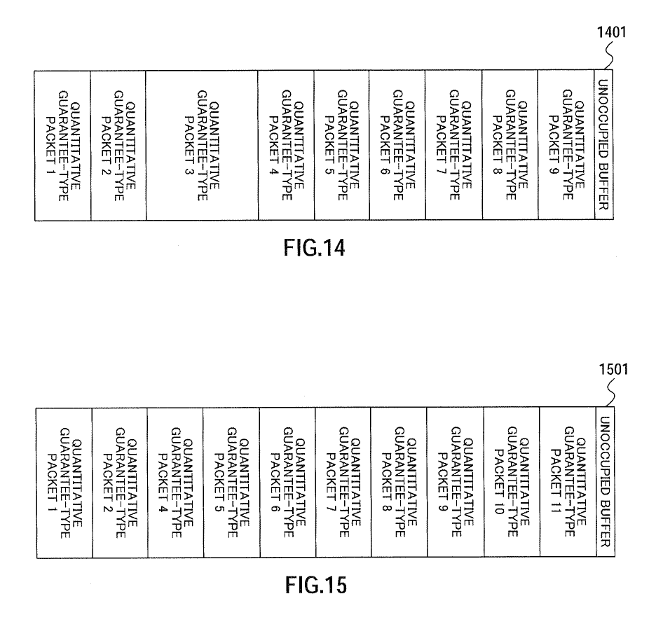

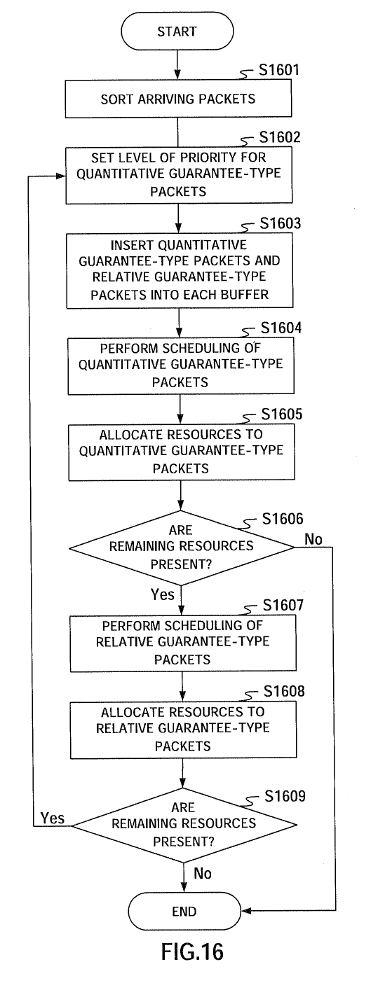

FIG. 14 through FIG. 16 are views for describing the scheduling process and radio resource allocation control in the radio base station according to embodiment 7 of the present embodiment. FIG. 14 and FIG. 15 are views for describing the radio resource allocating method in the radio base station according to embodiment 7 of the present invention. FIG. 16 is a flowchart for describing the scheduling process and radio resource allocation control in the radio base station according to embodiment 7 of the present invention.

FIG. 14 and FIG. 15 show the storage condition (allocation condition) of buffer 118 in the case that eleven quantitative guarantee-type packets are successively sent from core network 103. Here, quantitative guarantee-type packet 1 and quantitative guarantee-type packet 2 are speech communication packets, quantitative guarantee-type packet 3 is for instance a streaming packet, other than speech communication, and quantitative guarantee-type packet 4 through quantitative guarantee-type packet 11 are speech communication packets.

In this case, assuming that radio resource allocation is performed taking into consideration solely the arrival order of packets, since packets sent from core network 103 are stored in buffer 118 in the order of their arrival, a limited unoccupied buffer 1401 is left in buffer 118, and quantitative guarantee-type packet 1 through quantitative guarantee-type packet 9 are stored in order in buffer 118, as shown in FIG. 14. In other words, radio resources are allocated to the first nine users, and no radio resources can be allocated to the two users that desire to perform speech communication.

This cannot accommodate an external condition where speech communication becomes necessary when a disaster, etc. occurs. Thus, the level of priority is set for the quantitative guarantee-type packets as well, thereby allowing to increase the number of users that desire to perform speech communication. This means that, in the above-described example, quantitative guarantee-type packets 1 through 2 and 4 through 11 are given priority over quantitative guarantee-type packet 3. As a result, as shown in FIG. 15, a limited unoccupied buffer 1501 is left in buffer 118 to allow the quantitative guarantee-type packets 1 through 2 and 4 through 11 to be stored in order, which makes it possible to allocate radio resources to all ten users that desire to perform radio communication. Next, a description will be given with reference to FIG. 16.

In FIG. 16, packets that arrive from core network 103 at the radio base station are sorted into quantitative guarantee-type packets and relative guarantee-type packets (step S1601), and the level of priority is set for these sorted quantitative guarantee-type packets (step S1602). Then, the sorted quantitative guarantee-type packets and the relative guarantee-type packets are inserted into buffer 118 (step S1603). Then, scheduling of quantitative guarantee-type packets is carried out (step S1604), and resources are allocated to the quantitative guarantee-type packets (step S1605).

Next, the presence or absence of remaining radio resources is checked (step S1606). If no remaining radio resources are present (“No” in step S1606), the flow ends here. However, if remaining radio resources are present (“Yes” in step S1606), scheduling (step S1607) and allocation of radio resources (step S1608) for relative guarantee-type packets are carried out.

Then, the presence or absence of remaining radio resources is further checked (step S1609). If remaining radio resources are present (“Yes” in step S609), the flow returns to step S1602, in which the level of priority is once again set for the quantitative guarantee-type packets. If no remaining radio resources are present (“No” in step S1609), the flow ends.

According to the present embodiment 7, since it is possible to allocate radio resources, that are weighted based on the content of speech communication, motion picture or streaming, to the quantitative guarantee-type packets as well, it is possible to preferentially allocate radio resources to speech communication. Accordingly, the number of users capable of speech communication can be increased, and it becomes possible to suitably accommodate external conditions in which speech communication becomes necessary at the time when a disaster or the like occurs.

### Embodiment 8

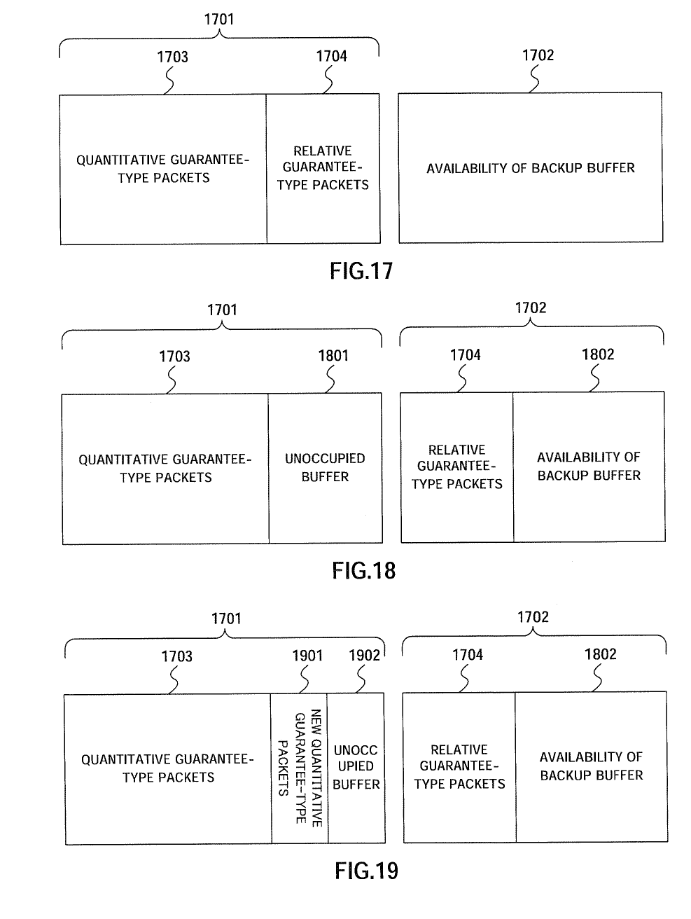

FIG. 17 through FIG. 19 are views for describing a scheduling process and radio resource allocation control in a radio base station according to embodiment 8 of the present invention. In the present embodiment 8, a method of storing new quantitative guarantee-type packets in buffer 118 and allocation radio resources will be described.

As shown in FIG. 17, backup buffer 1702 is prepared for buffer 1701 which is normally used, as buffer 118. Normal use buffer 1701 is divided into a buffer for quantitative guarantee-type packets 1703 and a buffer for relative guarantee-type packets 1704.

If new quantitative guarantee-type packets arrive from core network 103, relative guarantee-type packets 1704 are once shifted from normal use buffer 1701 to backup buffer 1702, thereby generating unoccupied buffer 1801 inside normal use buffer 1701.

Then, as shown in FIG. 19, new quantitative guarantee-type packets that arrive from core network 103 are stored in unoccupied buffer 1801 generated inside normal use buffer 1701. Accordingly, unoccupied buffer 1801 becomes unoccupied buffer 1902, which is obtained by subtracting the portion of new quantitative guarantee-type packet 1901.

According to the present embodiment 8, since a backup buffer is provided for the normal use buffer, when a new quantitative guarantee-type packet arrives, the relative guarantee-type packets present inside the normal use buffer are temporarily shifted to the backup buffer, and the available radio resources are allocated to the user quantitative guarantee-type packets which are newly accepted, thereby making it possible to accommodate emergency call situations such as emergency calls to the police. Thus, it is possible to reliably secure resources for packets with a high level of priority, among the quantitative guarantee-type packets.

### Embodiment 9

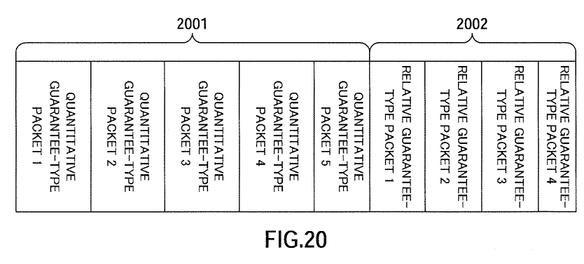

FIG. 20 is a view for describing a method of allocating radio resources in the radio base station according to embodiment 9 of the present invention. In the present embodiment 9, the radio resources or buffer 118 or normal use buffer 1701 or backup buffer 1702 are partitioned into those being used for quantitative guarantee-type packets 2001 and those being used for relative guarantee-type packets 2002, based on the proportion determined by required proportion determining sections 123 and 513, as shown in FIG. 20.

In this case, if buffer 118 or normal use buffer 1701 or backup buffer 1702 overflows, no more packets are accepted.

According to embodiment 9, the management of radio resources or buffers or backup buffer becomes easy. In particular, if the quantitative guarantee-type packets and the relative guarantee-type packets concentrate in the radio base station and overflow the radio resources, it is possible to allocate a communication opportunity equally to the quantitative guarantee-type packets and relative guarantee-type packets.

The present application is based on Japanese Patent Application No. 2005-039261, filed on Feb. 16, 2005, the entire content of which is expressly incorporated by reference herein.

### INDUSTRIAL APPLICABILITY

The radio base station, control apparatus and wireless communications system perform scheduling suitable for external conditions such as disaster conditions, event information, traffic conditions and weather conditions and the like in a cell, thereby being able to suitably accommodate new users that desire to communicate quantitative guarantee-type packets, and are suitable for optimally controlling radio resource and buffer allocation when it is desired to increase the amount of quantitative guarantee-type users as much as possible.

1. A radio base station comprising:
a packet sorting section that sorts packets into quantitative guarantee type packets having a required value for quality of communication and relative guarantee type packets not having said required value;
a proportion determining section that determines a proportion of the quantitative guarantee type packets to the relative guarantee type packets sorted by the packet sorting section, and a total amount of required packets;
an intra-cell environment determining section that determines an intra-cell environment based on external information required from a public network;
a scheduling table that provides in advance different types of scheduling patterns;
a scheduling pattern selecting section that retrieves an applicable scheduling pattern from the scheduling table based on the proportion and the total amount of required packets determined by the proportion determining section, and external conditions inside the cell determined by the intra-cell environment determining section;
a scheduling processing section that performs scheduling of a transmission order of the quantitative guarantee type packets and relative guarantee type packets sorted by the packet sorting section, based on the scheduling pattern selected by the scheduling pattern selecting section; and
a radio resource allocating section that performs an allocation of radio resources to the quantitative guarantee type packets and relative guarantee type packets scheduled by the scheduling processing section.

2. The radio base station of claim 1, wherein, if the scheduling processing section performs the scheduling such that the quantitative guarantee type packets and the relative guarantee type packets are transmitted alternately, the radio resource allocating section attempts, after radio resources are allocated to the quantitative guarantee type packets and the relative guarantee type packets, to secure a predetermined amount of unoccupied resources, and, if the predetermined amount of unoccupied resources cannot be secured, the radio resource allocating section does not allocate radio resources to new packets.

3. The radio base station of claim 1, wherein, if the scheduling processing section performs the scheduling such that the quantitative guarantee type packets and the relative guarantee type packets are transmitted together sandwiching the predetermined amount of unoccupied resources, the radio resource allocating section sorts the radio resources into resources for the quantitative guarantee type packets and resources for the relative guarantee type packets in advance and allocates the resources.

4. The radio base station of claim 1, wherein the scheduling processing section and the radio resource allocating section first perform scheduling and radio resource allocation for the quantitative guarantee type packets, and, when unoccupied resources are present, perform scheduling and radio resource allocation for the relative guarantee type packets.

5. The radio base station of claim 1, wherein:
the scheduling processing section sets a level of priority for the quantitative guarantee type packets sorted by the packet sorting section; and
the scheduling processing section and the radio resource allocating section first perform scheduling and radio resource allocation for the quantitative guarantee type packets, and, when unoccupied resources are present, perform scheduling and radio resource allocation for the relative guarantee type packets, and, when later unoccupied resources are present, perform scheduling and radio resource allocation for the quantitative guarantee type packets once again.

6. The radio base station of claim 1, further comprising a backup buffer for a general use buffer used normally for the quantitative guarantee type packets and relative guarantee type packets, wherein:
upon arrival of new quantitative guarantee type packets, the scheduling processing section stores the new quantitative guarantee type packets in an unoccupied buffer given by shifting the relative guarantee type packets from the normal use buffer into the backup buffer; and
the radio resource allocating section performs an allocation of radio resources to the new quantitative guarantee type packets stored in the normal use buffer.

7. The radio base station of claim 1, wherein the scheduling processing section and the radio resource allocating section use the radio resources or the buffer, or a backup buffer if the backup buffer is provided for the buffer, by distributing the quantitative guarantee type packets and the relative guarantee type packets according to the proportion of the number of required users determined by the proportion determining section.

8. A control apparatus that controls a radio base station that communicates packets with a plurality of mobile stations, the control apparatus comprising: a packet sorting section that sorts packets into quantitative guarantee type packets having a required value for quality of communication and relative guarantee type packets not having said required value;
a proportion determining section that determines a proportion of the quantitative guarantee type packets to the relative guarantee type packets sorted by the packet sorting section, and a total amount of required packets;
an intra-cell environment determining section that determines an intra-cell environment based on external information required from a public network;
a scheduling table that provides in advance different types of scheduling patterns;
a scheduling pattern selecting section that retrieves an applicable scheduling pattern from the scheduling table based on the proportion and the total amount of required packets determined by the proportion determining section, and external conditions inside the cell determined by the intra-cell environment determining section;
a scheduling processing section that performs scheduling of a transmission order of the quantitative guarantee type packets and relative guarantee type packets sorted by the packet sorting section, based on the scheduling pattern selected by the scheduling pattern selecting section; and
a radio resource allocating section that performs an allocation of radio resources to the quantitative guarantee type packets and relative guarantee type packets scheduled by the scheduling processing section.

9. A wireless communication method comprising:
a packet sorting step of sorting packets into quantitative guarantee type packets having a required value for quality of communication and relative guarantee type packets not having said required value;
a proportion determining step of determining a proportion of the quantitative guarantee type packets to the relative guarantee type packets sorted in the packet sorting step, and a total amount of required packets;
an intra-cell environment determining step of determining an intra-cell environment based on external information required from a public network;
a scheduling pattern selecting step of retrieving an applicable scheduling pattern from a scheduling table, said table providing in advance different types of scheduling patterns, based on the proportion and the total amount of required packets determined in the proportion determining step, and external conditions inside the cell determined in the intra-cell environment determining step;
a transmission order control step of performing scheduling of a transmission order of the quantitative guarantee type packets and relative guarantee type packets sorted in the packet sorting step, based on the scheduling pattern selected in the scheduling pattern selecting step; and
performing an allocation of radio resources to the quantitative guarantee type packets and relative guarantee type packets scheduled in the scheduling processing step.
